(19) United States
(12) Patent Application Publication
(10) Pub. No.: US 2024/0211737 A1
(43) Pub. Date: Jun. 27, 2024

(54) APPARATUS AND METHOD WITH ENCRYPTED DATA NEURAL NETWORK OPERATION

(71) Applicants: SAMSUNG ELECTRONICS CO., LTD., Suwon-si (KR); Seoul National University R&DB Foundation, Seoul (KR); Daegu Gyeongbuk Institute of Science and Technology, Daegu (KR); Industry Academic Cooperation Foundation, Chosun University, Gwangju (KR)

(72) Inventors: Jong Seon NO, Seoul (KR); Yongjune KIM, Daegu (KR); Eun Sang LEE, Seoul (KR); Jung Hyun LEE, Seoul (KR); Young Sik KIM, Gwangju (KR); Joon Woo LEE, Seoul (KR)

(73) Assignees: SAMSUNG ELECTRONICS CO., LTD., Suwon-si (KR); Seoul National University R&DB Foundation, Seoul (KR); Daegu Gyeongbuk Institute of Science and Technology, Daegu (KR); Industry Academic Cooperation Foundation, Chosun University, Gwangju (KR)

(21) Appl. No.: 18/470,589

(22) Filed: Sep. 20, 2023

(30) Foreign Application Priority Data
Dec. 22, 2022 (KR) 10-2022-0182216

(51) Int. Cl. G06N 3/048; G06F 17/17; H04L 9/00

(52) U.S. Cl. CPC G06N 3/048; G06F 17/17; H04L 9/008

(57) ABSTRACT

An apparatus includes one or more processors configured to execute instructions; and one or more memories storing the instructions; wherein the execution of the instructions by the one or more processors configures the one or more processors to generate an approximate polynomial, approximating a neural network operation, of a portion of a deep neural network model that is configured to receive input data, by using weighted least squares based on parameters corresponding to the generation of the approximate polynomial, a mean of the input data, and a standard deviation of the input data; and generate a homomorphic encrypted data operation result based on the input data and the approximate polynomial that approximates the neural network operation.

### CROSS-REFERENCE TO RELATED APPLICATIONS

This application claims the benefit under 35 USC § 119(a) of Korean Patent Application No. 10-2022-0182216, filed on Dec. 22, 2022, in the Korean Intellectual Property Office, the entire disclosure of which is incorporated herein by reference for all purposes.

### BACKGROUND

### 1. Field

The following description relates to an apparatus and method with encrypted data neural network operation.

### 2. Description of Related Art

Homomorphic encryption enables arbitrary operations between encrypted data without decrypting the encrypted data. Typical homomorphic encryption is typically lattice-based and thus resistant to quantum algorithms.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an apparatus may include one or more processors configured to execute instructions; and one or more memories storing the instructions; wherein the execution of the instructions by the one or more processors configures the one or more processors to generate an approximate polynomial, approximating a neural network operation, of a portion of a deep neural network model that is configured to receive input data, by using weighted least squares based on parameters corresponding to the generation of the approximate polynomial, a mean of the input data, and a standard deviation of the input data; and generate a homomorphic encrypted data operation result based on the input data and the approximate polynomial that approximates the neural network operation.

The execution of the instructions by the one or more processors may configure the one or more processors to implement the deep neural network model, including a generation of the input data by implementing another portion of the deep neural network model, the generation of the approximate polynomial, and the generation of the homomorphic encrypted data operation result.

The execution of the instructions by the one or more processors may configure the one or more processors to perform the generation of an approximate polynomial and the generation of respective homomorphic encrypted data operation results for plural portions of the deep neural network model that have respective neural network operations that are each configured to receive corresponding input data respectively generated by plural other portions of the deep neural network model; and generate a result of the deep neural network model dependent on the corresponding input data respectively generated by the plural other portions of the deep neural network model and the respective homomorphic encrypted data operation results.

The parameters may include a correction constant for correcting a degree of the approximate polynomial and the standard deviation, wherein the weighted least squares is based on a corrected standard deviation based on the correction constant, and wherein the generation of the homomorphic encrypted data operation result is based on the approximate polynomial with a corrected degree based on the correction constant.

For the generation of the approximate polynomial, the one or more processors may be configured to calculate the standard deviation; and generate the corrected standard deviation by multiplying the standard deviation by the correction constant.

For the generation of the approximate polynomial, the one or more processors may be configured to set a probability density function of the input data based on the mean, the standard deviation, and the correction constant, and wherein the weighted least squares is based on the probability density function.

For the generation of the approximate polynomial, the one or more processors may be configured to calculate a mean square error based on the probability density function; and generate the approximate polynomial that minimizes the mean square error that is based on the degree of the approximate polynomial and the probability density function.

The neural network operation may include a rectified linear unit (ReLU), and wherein, for the generation of the approximate polynomial, the one or more processors may be configured to calculate the mean square error based on a product of the probability density function and a square of a difference between the ReLU and the updated approximate polynomial.

The neural network operation comprises a rectified linear unit (ReLU), and wherein the one or more processors are configured to calculate the mean and the standard deviation based on the input data.

For the generation of the approximate polynomial, the one or more processors may be configured to calculate a first coefficient and a second coefficient based on a degree of the approximate polynomial, the mean, and the standard deviation; and generate the approximate polynomial based on a product of the first coefficient and the second coefficient.

For the generation of the approximate polynomial, the one or more processors may be configured to calculate the first coefficient and the second coefficient based on a value obtained by dividing the mean by the standard deviation.

In another general aspect, a processor-implemented method may include generating an approximate polynomial, approximating a neural network operation, of a portion of a deep neural network model that is configured to receive input data, by using weighted least squares based on parameters corresponding to the generation of the approximate polynomial, a mean of input data, and a standard deviation of the input data; and generating a homomorphic encrypted data operation result based on the input data and the approximate polynomial that approximates the neural network operation.

The generating of the approximate polynomial may include setting a probability density function of the input data based on the mean, the standard deviation, and the correction constant; and wherein the weighted least squares is based on the probability density function.

The generating of the approximate polynomial based on the probability density function may include calculating a mean square error based on the probability density function; and generating the approximate polynomial that minimizes the mean square error that is based on the degree of the approximate polynomial and the probability density function.

The calculating of the mean square error may include calculating the mean square error based on a product of the probability density function and a square of a difference between the ReLU and the updated approximate polynomial.

The method may further include calculating, based on the input data of the ReLU, the mean and the standard deviation.

The generating of the approximate polynomial may include calculating a first coefficient and a second coefficient based on a degree of the approximate polynomial, the mean, and the standard deviation; and generating the approximate polynomial based on a product of the first coefficient and the second coefficient.

The method may include calculating the first coefficient and the second coefficient based on a value obtained by dividing the mean by the standard deviation.

### BRIEF DESCRIPTION OF THE DRAWINGS

FIG. 1 illustrates an example computing apparatus according to one or more embodiments.

FIG. 2 illustrates an example method of generating an approximate polynomial according to one or more embodiments.

FIG. 3 illustrates an example method of calculating a mean (or an average) and a standard deviation of input data according to one or more embodiments.

FIG. 4 illustrates an example method of generating an approximate polynomial according to one or more embodiments.

FIG. 5 illustrates an example method of calculating a coefficient of an approximate polynomial according to one or more embodiments.

FIG. 6 illustrates an example graph demonstrating a correction constant for correction of a standard deviation according to one or more embodiments.

FIG. 7 illustrates an example method according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment, e.g., as to what an example or embodiment may include or implement, means that at least one example or embodiment exists where such a feature is included or implemented, while all examples are not limited thereto.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C’, and the like are intended to have disjunctive meanings, and these phrases “at least one of A, B, and C”, “at least one of A, B, or C’, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing. It is to be understood that if a component (e.g., a first component) is referred to, with or without the term “operatively” or “communicatively,” as “coupled with,” “coupled to,” “connected with,” or “connected to” another component (e.g., a second component), it means that the component may be coupled with the other component directly (e.g., by wire), wirelessly, or via a third component.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein.

A machine learning model (e.g., a neural network model) may be utilized for homomorphic encrypted data. For example, it is found that a polynomial with a low degree may be used, e.g., as an activation function, to perform a neural network operation. However, layers of the neural network model may not be stacked when the one polynomial of the low degree is utilized, and thus it becomes difficult to achieve high performance.

On the other hand, it is found that a polynomial with a high degree is typically required as the activation function to accurately approximate a rectified linear unit (ReLU) of the neural network operation. Thus, in this case, multiple times of bootstrapping have been typically required to implement the polynomial as the activation function in a deep neural network, which requires an excessive amount of time to implement.

Additionally, it is found that, in such a typical neural network operation for the homomorphic encrypted data using the high degree polynomial, the typical neural network model needs to be retrained based on the high degree polynomial having replaced the existing activation function of the neural network model, e.g., having replaced a standard ReLU activation function in the neural network model, which also requires significantly more resources than the standard ReLU function or other replaced activation function. These operations not only have certain limitations to achieve high performance, but are also very time consuming and require significant resources.

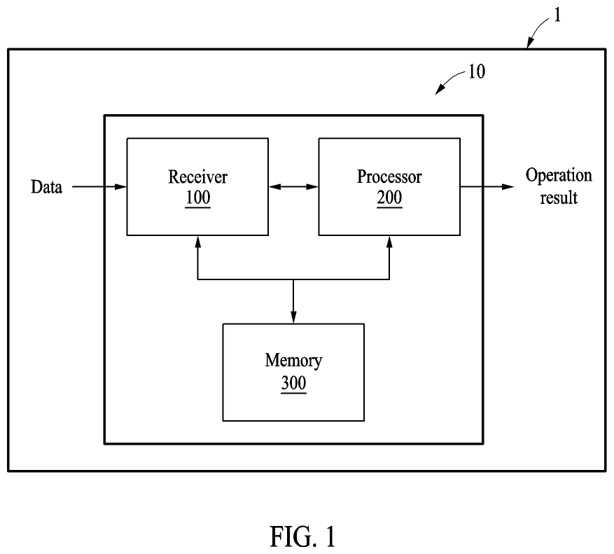

FIG. 1 illustrates an example computing apparatus according to one or more embodiments.

Referring to FIG. 1, an example computing apparatus 10 may be configured to perform a neural network operation of a neural network model. In an example, the computing apparatus 10 may perform training and/or inference operations of a machine leaning model for homomorphic encrypted data. The computing apparatus 10 may also be a component or operation of an electronic device 1, or the computing apparatus may be the electronic device.

In an example, the computing apparatus 10 may be configured to perform a neural network operation of homomorphic encrypted data. Homomorphic encryption may refer to a method of encryption configured to allow various operations to be performed on data that is still encrypted. In homomorphic encryption, a result of an operation using ciphertexts may become a new ciphertext, and a plaintext obtained by decrypting the ciphertext may be the same as an operation result of the original data before the encryption.

A neural network model is a type of machine learning model having a problem-solving or other inference capability implemented through the nodes of respective layers of the neural network model with connections therebetween.

The neural network model may include one or more layers, each including one or more nodes. The neural network model may be trained to infer a result from an input by incrementally adjusting weights of the nodes through training. The nodes of each of the layers of the neural network model may respectively include weights corresponding to the respectively connected outputs of a previous layer to respective nodes of a current layer. Each of such nodes of the plural layers may also include respective biases that may be determined during training, for example. The connections between the nodes may also be considered to be weighted connections, in which case such weights may be applied to respective outputs of a previous layer, for example, some or all of which may be referred to as respective activations. In such an example, one or more respective weighted activations may be understood to be input to each node of a current layer.

As non-limiting example, the neural network model may include a deep neural network (DNN). The neural network model may include any one of a convolutional neural network (CNN), a recurrent neural network (RNN), a perceptron, a multilayer perceptron, a feed forward (FF), a radial basis network (RBF), a deep feed forward (DFF), a long short-term memory (LSTM), a gated recurrent unit (GRU), an auto encoder (AE), a variational auto encoder (VAE), a denoising auto encoder (DAE), a sparse auto encoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural turning machine (NTM), a capsule network (CN), a Kohonen network (KN), a binarized neural network (BNN), and/or an attention network (AN).

The computing apparatus 10 may be in a personal computer (PC), a data server, or a portable device, or the electronic device 1 may be the PC, the data server, or the portable device.

The portable device may be implemented as, as non-limiting examples, a laptop computer, a mobile phone, a smartphone, a tablet PC, a mobile internet device (MID), a personal digital assistant (PDA), an enterprise digital assistant (EDA), a digital still camera, a digital video camera, a portable multimedia player (PMP), a personal or portable navigation device (PND), a handheld game console, an e-book, or a smart device. The smart device may be implemented as a smart watch, a smart band, a smart ring, or the like.

The computing apparatus 10 may perform a neural network operation using an accelerator. The computing apparatus 10 may be implemented inside or outside the accelerator.

As non-limiting examples, the accelerator may include a neural processing unit (NPU), a graphics processing unit (GPU), a field-programmable gate array (FPGA), an application-specific integrated circuit (ASIC), or an application processor (AP). Alternatively, the accelerator may be implemented as a software computing environment, such as a virtual machine or the like.

In an example of FIG. 1, the computing apparatus 10 may include a receiver 100, a processor 200, and a memory 300. The receiver 100, processor 200 and memory 300 are each also representative of respectively different or same receiver, processor, and memory of the electronic device 1.

The receiver 100 may include a receiving interface, through which various data are received by the receiver 100. The receiver 100 may receive data from an external device or the memory 300. The receiver 100 may output the received data to the processor 200.

The receiver 100 may receive data for performing a neural network operation and parameters for generating an approximate polynomial corresponding to the neural network operation.

The data for performing the neural network operation may include input data input to a neural network model or a layer of the neural network model. The parameters for generating the approximate polynomial may include a degree of the approximate polynomial and a correction constant for correcting a standard deviation. The neural network operation (e.g., respective activation functions of nodes of one or more layers) may include a rectified linear unit (ReLU).

The processor 200 may process data stored in the memory 300. The processor 200 may execute a computer-readable instructions (e.g., code or software) stored in the memory 300. The execution of the instructions by the processor 200 may configure the processor 200 to perform any one or any combinations of the operations/methods described herein.

The processor 200 may include one or more data processing devices embodied by hardware having a circuit of a physical structure to execute desired operations. The desired operations may include, for example, such instructions included in a program, as a non-limiting example, which may be stored in the memory 300. The execution of the instructions by the one or more data processing devices may configure the processor 200 to perform any one or any combinations of the operations/methods described herein.

The one or more hardware-implemented data processing devices may each include, for example, a microprocessor, a central processing unit (CPU), a processor core, a multi-core processor, a multiprocessor, an application-specific integrated circuit (ASIC), and a field-programmable gate array (FPGA), as non-limiting examples.

The processor 200 may be configured to calculate a mean and a standard deviation of respective input data of one or more layers (e.g., ReLU layers) of a neural network model based on the data for performing the neural network operation. In an example, the processor 200 may calculate the mean and the standard deviation based on input data of/to the ReLU. The processor 200 may correct the standard deviation by multiplying the standard deviation by the correction constant.

The processor 200 may be configured to generate an approximate polynomial that approximates the neural network operation by using weighted least squares based on parameters, a mean, and a standard deviation. For example, the processor 200 may generate an approximate polynomial that approximates the ReLU.

The processor 200 may be configured to set a probability density function of the input data based on the mean, standard deviation, and correction constant of the input data. The processor 200 may generate the approximate polynomial based on the probability density function.

The processor 200 may be configured to calculate a mean square error (or a mean squared error) based on the probability density function. The processor 200 may generate a polynomial that minimizes a mean square error, as the approximate polynomial, based on the degree of the approximate polynomial and the probability density function. The processor 200 may calculate the mean square error based on multiplication of the probability density function and the square of a difference between a standard ReLU and the approximate polynomial. As a non-limiting example, a standard ReLU may assign a value of zero to negative input values and assign values to positive input values according to a linear inclination, e.g., lower positive input values would have assigned values lower on the inclination and higher positive input values would have assigned values higher on the inclination.

The processor 200 may be configured to calculate a first coefficient and a second coefficient based on the degree of the approximate polynomial, the mean, and the standard deviation. The processor 200 may generate an approximate polynomial by calculating a target coefficient of the approximate polynomial based on a multiplication of the first coefficient and the second coefficient. The processor 200 may calculate the first coefficient and the second coefficient based on a value obtained by dividing the mean by the standard deviation.

The processor 200 may be configured to generate an operation result by performing a neural network operation based on the final approximate polynomial.

The memory 300 may be configured to store computer-readable instructions executable by the processor 200. For example, the instructions include instructions for performing any one or any combinations of the operations of the processor 200 and/or each component of the processor 200.

The memory 300 may be embodied by a volatile or non-volatile memory device.

As non-limiting examples, the volatile memory device may be implemented as a dynamic random access memory (DRAM), a static random access memory (SRAM), a thyristor RAM (T-RAM), a zero capacitor RAM (Z-RAM), or a twin transistor RAM (TTRAM).

As non-limiting example, the non-volatile memory device may be implemented as an electrically erasable programmable read-only memory (EEPROM), a flash memory, a magnetic RAM (MRAM), a spin-transfer torque-MRAM (STT-MRAM), a conductive bridging RAM (CBRAM), a ferroelectric RAM (FeRAM), a phase change RAM (PRAM), a resistive RAM (RRAM), a nanotube RRAM, a polymer RAM (PoRAM), a nano-floating gate memory (NFGM), a holographic memory, a molecular electronic memory device, or an insulator resistance change memory.

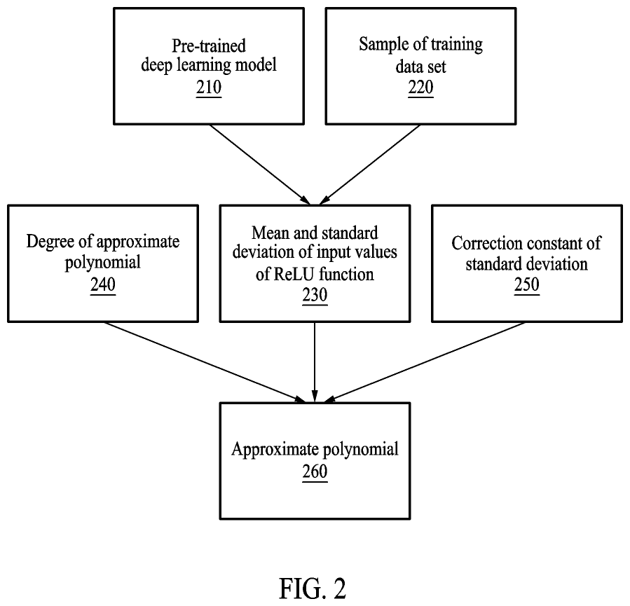

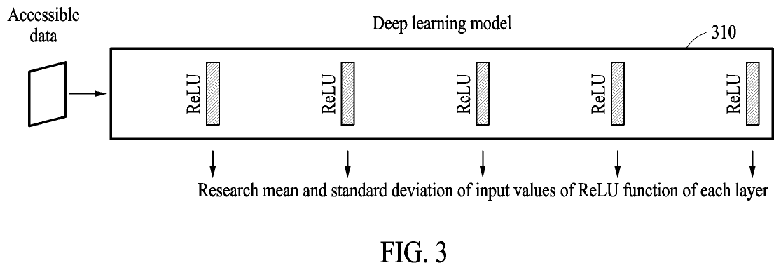

FIG. 2 illustrates an example operation of generating an approximate polynomial by a computing apparatus and FIG. 3 illustrates an example operation of calculating a mean and a standard deviation of input data, according to one or more embodiments.

Referring to FIGS. 2 and 3, a processor (e.g., the processor 200 of FIG. 1) may be configured to perform a neural network operation of fully homomorphic encrypted data. In an example, the processor 200 may approximate a ReLU (or a ReLU function) included in the neural network operation. The processor 200 may effectively approximate the ReLU to a polynomial in consideration of a distribution of the input data. The ReLU may be expressed by ReLU(x)=max{x,0}.

The processor 200 may be configured to generate an approximate polynomial that approximates the neural network operation by using the weighted least squares. In an example, the processor 200 may calculate a mean and a standard deviation of input values of the ReLU function 230 based on a pre-trained machine learning model (e.g., the deep learning model 210 or a neural network 310, as non-limiting examples) and a sample of a training data set 220. A size of the sample of the data set may be predetermined based on determined operation requirements or defined by a user. A degree n of an approximate polynomial may be a natural number.

The processor 200 may be configured to obtain information on corresponding distribution of respective input data to each ReLU included in a plurality of layers of the neural network 310. For example, the neural network 310 may have respective ReLU layers provided after a corresponding other neural network operation (e.g., a convolution operation), or the illustrated ReLU layers may be final operations of respective layers that each also include the corresponding other neural network operation. Each information on a distribution of respective input data to each of the ReLU layers may include a corresponding mean and standard deviation of the respective input data. For each ReLU layer, the processor 200 may generate a final corresponding approximate polynomial that minimizes a mean square error by using the corresponding mean and standard deviation. Here, while examples herein may be performed for each of such ReLU layers, based on the respective input data to each ReLU layer, for convenience of explanation examples herein may be provided through an explanation of a single ReLU layer.

The processor 200 may be configured to effectively perform polynomial approximation according to input data values. In an example, the processor 200 may design a deep learning model (e.g., with one or more example ReLU layers/operations) for fully homomorphic encrypted data with high accuracy even though a low polynomial degree is used.

The processor 200 may be configured to obtain a distribution of input data to a ReLU layer. The processor 200 may calculate a mean, variance, and/or standard deviation of the input data. In an example, the processor 200 may calculate the mean, variance, and/or standard deviation of the input data of/to the ReLU by analyzing the training data set on the pre-trained deep learning model 210.

The processor 200 may be configured to generate an approximate polynomial 260 that approximates the neural network operation based on the mean and standard deviation 230, a degree of an approximate polynomial 240, and a correction constant of the standard deviation 250.

The mean and standard deviation of the input data of the ReLU of an i-th layer included in the neural network 310 are expressed by μᵢ and σᵢ, respectively. The processor 200 may be configured to calculate a probability density function based on the mean and standard deviation. The probability density function, when a correction constant of the standard deviation of the i-th layer is kᵢ, may be expressed by Equation 1.

$$p ( x ) = \frac{1}{\sqrt{2 {π ( {k}_{i} {σ}_{i} )}^{2}}} exp ( - \frac{{( x - {μ}_{i} )}^{2}}{2 {( {k}_{i} {σ}_{i} )}^{2}} ) \qquad Equation 1$$

The processor 200 may configured to calculate a mean square error based on the probability density function. The mean square error may be expressed by Equation 2.

$${\int }_{- ∞}^{∞} p ( x ) {( ReLU ( x ) - r ( x ) )}^{2} dx \qquad Equation 2$$

The processor 200 may be configured to generate a nth degree polynomial r(x) that minimizes the mean square error as the approximate polynomial 260.

In one or more examples, because the neural network 210 may already include trained parameters of various portions of the neural network 210 (e.g., of respective convolution operations), these parameters may not be re-trained and the resultant neural network that uses these trained parameters and the approximate polynomial 360 (e.g., instead of or replacing a standard ReLU in the neural network 210) to generate a result of the neural network with respect to the encrypted data.

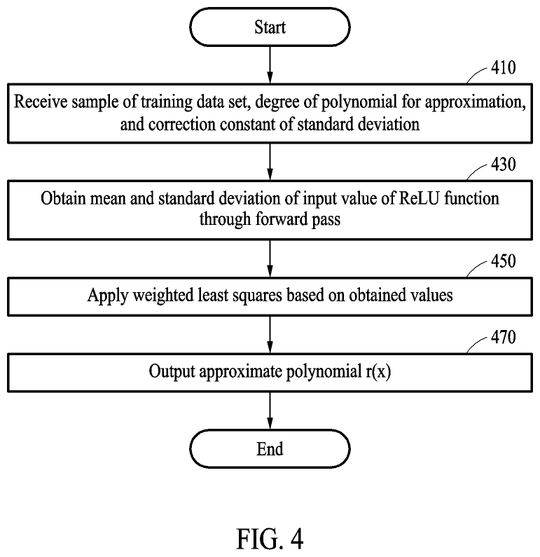

FIG. 4 illustrates an example method of generating an approximate polynomial according to one or more embodiments. As a non-limiting example, the example method of generating the approximate polynomial may include operations 410 through 470, and some of these operations may be performed, for example, in time series, sequentially, or any suitable order, or with any additional operation(s), which may optimize the method of generating the approximate polynomial.

Referring to FIG. 4, in operation 410, a processor (e.g., the processor 200 of FIG. 1) may be configured to receive a sample of a training data set, a degree of a polynomial for approximation, and a correction constant of a standard deviation.

In operation 430, the processor 200 may be configured to obtain a mean and a standard deviation of input data of the ReLU through forward pass.

In operation 450, the processor 200 may be configured to apply weighted least squares based on the obtained mean and the obtained standard deviation.

In operation 470, the processor 200 may be configured to output a polynomial that minimizes a mean square error of the weighted least squares as an approximate polynomial. When the ReLU operation is performed using a pre-trained deep learning model, e.g., the pre-trained deep learning model 210, instead of a standard ReLU operation of pre-trained deep learning model, the output polynomial (output approximate polynomial) may be used instead of the standard ReLU operation.

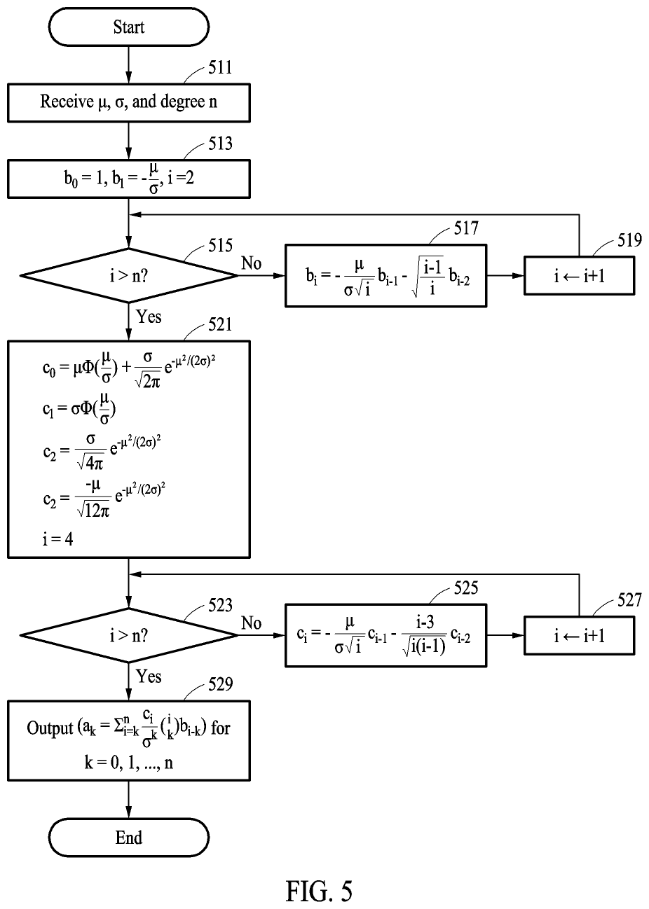

FIG. 5 illustrates an example method of calculating a coefficient of an approximate polynomial according to one or more embodiments. As a non-limiting example, the example method of calculating the coefficient of the approximate polynomial may include operations 511 through 529, and some of these operations may be performed, for example, in time series, sequentially, or any suitable order, or with any additional operation(s), which may optimize the method of calculating the coefficient of the approximate polynomial.

Referring to FIG. 5, a processor (e.g., the processor 200 of FIG. 1) may be configured to generate an approximate polynomial by calculating, based on the distribution of input data to a ReLU, a coefficient of a polynomial that approximates a ReLU by a predetermined (desired) degree.

In operation 511, the processor 200 may be configured to receive a mean and a standard deviation of input data, and a degree of an approximate polynomial. μ represents the mean of the input data and σ represents a value obtained by correcting the standard deviation of the input data. In an example, σ may represent a value obtained by multiplying a correction constant by the corrected standard deviation or the standard deviation of the input data. In an example, the processor 200 may calculate the mean and standard deviation of the input data.

n represents the degree of the approximate polynomial. The nth degree approximate polynomial may be in the form of p(x)=a₀+a₁x+ . . . +aₙxⁿ.

In operation 513, the processor 200 may be configured to calculate a first coefficient and a second coefficient based on the mean and the corrected standard deviation. In an example, the processor 200 may set an initial value of the first coefficient based on a value obtained by dividing the mean by the corrected standard deviation.

In operation 515, the processor 200 may be configured to identify/determine whether i is greater than n. In an example, when i is not greater than n, the processor 200 may be configured to calculate the first coefficient through operation 517. In operation 519, the processor may be configured to add 1 to i. Thus, the processor 200 may be configured to repeatedly perform operations 517 and 519 until the condition (i is greater than n) of operation 515 is satisfied.

In operation 521, the processor 200 may be configured to set an initial value of the second coefficient based on a value obtained by dividing the mean by the corrected standard deviation. Here, i may be set to 4.

In operation 523, the processor 200 may be configured to identify/determine whether i is greater than n. In operation 525, when i is not greater than n, the processor 200 may be configured to calculate the second coefficient through operation 525. In operation 527, the processor may be configured to add 1 to i. Thus, the processor 200 may be configured to repeatedly perform operations 525 and 527 until the condition (i is greater than n) of operation 523 is satisfied.

In operation 529, the processor 200 may be configured to generate a target coefficient aₖ, as the approximate polynomial, based on the first coefficient and the second coefficient.

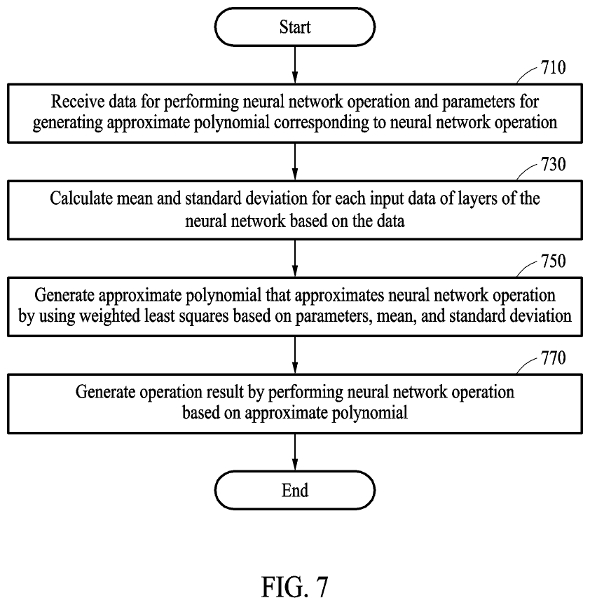

FIG. 6 illustrates an example graph demonstrating describing a correction constant for correction of a standard deviation according to one or more embodiments.

Referring to FIG. 6, a processor (e.g., the processor 200 of FIG. 1) may be configured to improve performance of the neural network operation by adjusting the correction constant. The processor 200 may be configured to generate/calculate a neural network operation result using the generated approximate polynomial, and analyze the generated operation result, which may include a determined abnormally large value or an overflow. Thus, the processor 200 may generate a new approximate polynomial by increasing a value of the correction constant in response to the abnormally large value or the overflow.

When performance of the neural network operation is deteriorated even though the operation result does not include the abnormally large value or the overflow, the processor 200 may generate a new approximate polynomial by reducing a value of the correction constant of the standard deviation.

The processor 200 may be configured to utilize a sample of accessible training data to adjust the correction constant of the standard deviation until target performance is obtained. The example of FIG. 6 may be a graph showing a correction constant of a standard deviation with which performance (e.g., Top-1 accuracy) of the neural network is maximized.

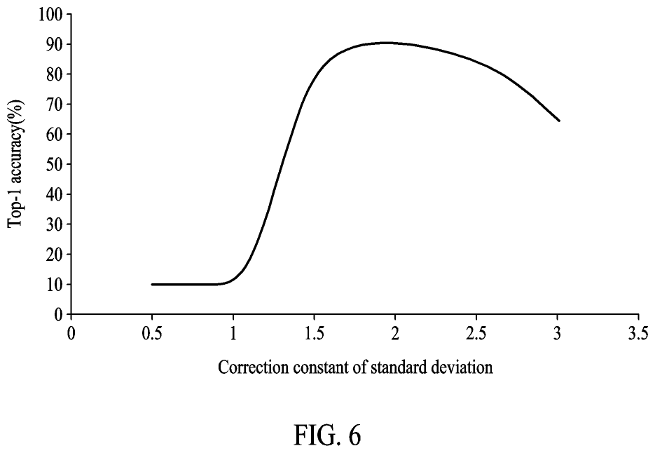

FIG. 7 illustrates an example method of a computing apparatus according to one or more embodiment. As a non-limiting example, the example method may include operations 710 through 770, and some of these operations may be performed, for example, in time series, sequentially, or any suitable order, or with any additional operation(s), which may optimize the method of the computing apparatus.

Referring to FIG. 7, in operation 710, a receiver (e.g., the receiver 100 of FIG. 1) may be configured to receive data for performing a neural network operation and parameters for generating an approximate polynomial corresponding to the neural network operation.

The data for performing the neural network operation may include respective input data input to a neural network model or respective layers of the neural network. The parameters for generating the approximate polynomial may include a degree of the approximate polynomial and a correction constant for correcting a standard deviation. The neural network operation may include a ReLU, as a non-limiting example.

In operation 730, the processor 200 may be configured to calculate a mean and a standard deviation for each input data of neural network operation layers (e.g., ReLU layers) of a neural network model based on the data for performing the neural network operation. In an example, the processor 200 may calculate the mean and the standard deviation based on input data of a ReLU (e.g., a ReLU layer or corresponding portion of a layer). The processor 200 may correct the standard deviation by multiplying the standard deviation by the correction constant.

In operation 750, the processor 200 may be configured to generate a corrected approximate polynomial that approximates the neural network operation (e.g., the ReLU operation) using weighted least squares based on parameters, a mean, and a standard deviation.

The processor 200 may be configured to set a probability density function of the input data based on the mean, standard deviation, and correction constant of the input data. The processor 200 may generate the approximate polynomial based on the probability density function.

The processor 200 may be configured to calculate a mean square error based on the probability density function. The processor 200 may generate a polynomial that minimizes the mean square error, as the approximate polynomial. The processor 200 may calculate the mean square error based on multiplication of the probability density function and the square of a difference between a standard ReLU and the approximate polynomial.

In one example, the processor 200 may be configured to calculate a first coefficient and a second coefficient based on the degree of the approximate polynomial, the mean, and the standard deviation. The processor 200 may generate an approximate polynomial by calculating a target coefficient based on multiplication of the first coefficient and the second coefficient. The processor 200 may calculate the first coefficient and the second coefficient based on a value obtained by dividing the mean by the standard deviation.

In operation 770, the processor 200 may be configured to generate an operation result by performing a neural network operation based on the approximate polynomial.

The processors, memories, electronic devices, apparatuses, and other apparatuses, devices, units, modules, and components described herein with respect to FIGS. 1-7 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-7 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROM, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An apparatus, comprising:
one or more processors configured to execute instructions; and
one or more memories storing the instructions;
wherein the execution of the instructions by the one or more processors configures the one or more processors to:
generate an approximate polynomial, approximating a neural network operation, of a portion of a deep neural network model that is configured to receive input data, by using weighted least squares based on parameters corresponding to the generation of the approximate polynomial, a mean of the input data, and a standard deviation of the input data; and
generate a homomorphic encrypted data operation result based on the input data and the approximate polynomial that approximates the neural network operation.

2. The apparatus of claim 1, wherein the execution of the instructions by the one or more processors configures the one or more processors to:
implement the deep neural network model, including a generation of the input data by implementing another portion of the deep neural network model, the generation of the approximate polynomial, and the generation of the homomorphic encrypted data operation result.

3. The apparatus of claim 2, wherein the execution of the instructions by the one or more processors configures the one or more processors to:
perform the generation of an approximate polynomial and the generation of respective homomorphic encrypted data operation results for plural portions of the deep neural network model that have respective neural network operations that are each configured to receive corresponding input data respectively generated by plural other portions of the deep neural network model; and
generate a result of the deep neural network model dependent on the corresponding input data respectively generated by the plural other portions of the deep neural network model and the respective homomorphic encrypted data operation results.

4. The apparatus of claim 1,
wherein the parameters comprise a correction constant for correcting a degree of the approximate polynomial and the standard deviation,
wherein the weighted least squares is based on a corrected standard deviation based on the correction constant, and
wherein the generation of the homomorphic encrypted data operation result is based on the approximate polynomial with a corrected degree based on the correction constant.

5. The apparatus of claim 4, wherein, for the generation of the approximate polynomial, the one or more processors are configured to:
calculate the standard deviation; and
generate the corrected standard deviation by multiplying the standard deviation by the correction constant.

6. The apparatus of claim 4, wherein, for the generation of the approximate polynomial, the one or more processors are configured to set a probability density function of the input data based on the mean, the standard deviation, and the correction constant, and
wherein the weighted least squares is based on the probability density function.

7. The apparatus of claim 6, wherein, for the generation of the approximate polynomial, the one or more processors are configured to:
calculate a mean square error based on the probability density function; and
generate the approximate polynomial that minimizes the mean square error that is based on the degree of the approximate polynomial and the probability density function.

8. The apparatus of claim 7, wherein the neural network operation comprises a rectified linear unit (ReLU), and
wherein, for the generation of the approximate polynomial, the one or more processors are configured to:
calculate the mean square error based on a product of the probability density function and a square of a difference between the ReLU and the updated approximate polynomial.

9. The apparatus of claim 1,
wherein the neural network operation comprises a rectified linear unit (ReLU), and
wherein the one or more processors are configured to calculate the mean and the standard deviation based on the input data.

10. The apparatus of claim 1, wherein, for the generation of the approximate polynomial, the one or more processors are configured to:
calculate a first coefficient and a second coefficient based on a degree of the approximate polynomial, the mean, and the standard deviation; and
generate the approximate polynomial based on a product of the first coefficient and the second coefficient.

11. The apparatus of claim 10, wherein, for the generation of the approximate polynomial, the one or more processors are configured to:
calculate the first coefficient and the second coefficient based on a value obtained by dividing the mean by the standard deviation.

12. A processor-implemented method, comprising:
generating an approximate polynomial, approximating a neural network operation, of a portion of a deep neural network model that is configured to receive input data, by using weighted least squares based on parameters corresponding to the generation of the approximate polynomial, a mean of input data, and a standard deviation of the input data; and
generating a homomorphic encrypted data operation result based on the input data and the approximate polynomial that approximates the neural network operation.

13. The method of claim 12,
wherein the parameters comprise a correction constant for correcting a degree of the approximate polynomial and the standard deviation,
wherein the weighted least squares are based on a corrected standard deviation based on the correction constant, and
wherein the generation of the homomorphic encrypted data operation result is based on the approximate polynomial with a corrected degree based on the correction constant.

14. The method of claim 13, wherein the generating of the approximate polynomial comprises:
setting a probability density function of the input data based on the mean, the standard deviation, and the correction constant; and
wherein the weighted least squares is based on the probability density function.

15. The method of claim 16, wherein the generating of the approximate polynomial based on the probability density function comprises:
calculating a mean square error based on the probability density function; and
generating the approximate polynomial that minimizes the mean square error that is based on the degree of the approximate polynomial and the probability density function.

16. The method of claim 17, wherein the calculating of the mean square error comprises:
calculating the mean square error based on a product of the probability density function and a square of a difference between the ReLU and the updated approximate polynomial.

17. The method of claim 12, wherein the neural network operation comprises a rectified linear unit (ReLU).

18. The method of claim 14, further comprising calculating, based on the input data of the ReLU, the mean and the standard deviation.

19. The method of claim 12, wherein the generating of the approximate polynomial comprises:
calculating a first coefficient and a second coefficient based on a degree of the approximate polynomial, the mean, and the standard deviation; and
generating the approximate polynomial based on a product of the first coefficient and the second coefficient.

20. The method of claim 19, wherein
calculating the first coefficient and the second coefficient is based on a value obtained by dividing the mean by the standard deviation.
